(19) United States
(12) Patent Application Publication
(10) Pub. No.: US 2018/0204693 A1
(43) Pub. Date: Jul. 19, 2018

(54) RECONFIGURABLE SWITCHING DEVICE

(71) Applicant: FIBAR GROUP S.A., Poznan (PL)

(72) Inventor: WOJCIECH GREDKA, Poznan (PL)

(21) Appl. No.: 15/407,091

(22) Filed: Jan. 16, 2017

(51) Int. Cl. H01H 13/702; H01H 13/705; H01H 13/52; G08C 17/02

(52) U.S. Cl. CPC H01H 13/702; G08C 17/02; H01H 13/52; H01H 13/705

(57) ABSTRACT

A device includes an engaging portion, a controller component, and a plurality of actuators. The engaging portion is configured to mechanically engage with at least one switch assembly. The plurality of actuators are capable of being actuated by the switch assembl(ies) when it/they are engaged with the engaging portion and depressed. The controller is configured to detect a first pattern of the plurality of actuators actuated at a time and responsively recognize a first type of switch assembly. The controller is also configured to detect a second (different) pattern of the plurality of actuators actuated at a time and responsively recognize a second (different) type of switch assembly.

### CROSS REFERENCE TO RELATED APPLICATIONS

[Not Applicable]

### BACKGROUND

The present invention relates to wall-mounted switches, and in particular, low-voltage wall-mounted switches that communicate wirelessly to control larger electrical loads, such as lights.

### SUMMARY

According to certain inventive techniques, a device includes an engaging portion, a controller component, and a plurality of actuators. The engaging portion is configured to mechanically engage with at least one switch assembly. The plurality of actuators are capable of being actuated by the switch assembl(ies) when it/they are engaged with the engaging portion and depressed. The controller is configured to detect a first pattern of the plurality of actuators actuated at a time and responsively recognize a first type of switch assembly. The controller is also configured to detect a second (different) pattern of the plurality of actuators actuated at a time and responsively recognize a second (different) type of switch assembly. The device may also include a communication component (e.g., a component that transmits and/or receives wireless communications) in communication with the controller component and configured to send communications to a remote device. The communications include information indicating whether the first type of switch assembly or the second type of switch assembly has been depressed. The device may also include a memory in which the controller component stores an identity of the one or more determined switch assemblies. The device may also include at least one battery receiving compartment each configured to receive batter(ies), which provide power to the controller component and the communication component.

According to a technique, the first pattern of the plurality of actuators includes only one actuator. Or, the first pattern includes a plurality of the actuators. The first pattern can differ from the second pattern in a horizontal and/or vertical dimension.

According to a technique, the engaging portion comprises a plurality of rows to receive the switch assemblies. The first type of switch assembly occupies only one of the rows and the second type of switch assembly occupies a plurality of the rows. According to one technique, the first type of switch assembly comprises a left portion and a right portion each of which is capable of being separately depressed, thereby causing actuation of different ones of the plurality of actuators.

According to certain inventive techniques, a method includes: (1) recognizing, with a controller component, that a first pattern of a plurality of actuators has been actuated at a time; and (2) identifying, with the controller component, that a first switch assembly has been depressed based on the recognition of the first pattern of the plurality of actuators. The method may further include communicating, with a communication component, the identity of the first switch assembly. The method may also include storing, in a memory in communication with the controller component, the identity of the first switch assembly. The method may include: recognizing, with the controller component, that a second pattern of a plurality of actuators has been actuated at a time; and identifying, with the controller component, that a second switch assembly has been depressed based on the recognition of the second pattern of the plurality of actuators. The first pattern of the plurality of actuators may be only one actuator or a plurality of actuators. The first pattern and second pattern may differ in a horizontal and/or vertical dimension.

### BRIEF DESCRIPTION OF SEVERAL VIEWS OF THE DRAWINGS

FIGS. 1A-1C illustrate different views of a switching device, according to certain inventive techniques.

FIG. 2 shows an exploded view of the device depicted in FIGS. 1A-1C, according to certain inventive techniques.

FIG. 3 shows the device depicted in FIGS. 1A-1C with further detail on one possible mechanism for engaging a switch assembly with the engaging portion, according to certain inventive techniques.

FIG. 4 shows five different types of switch assemblies, according to certain inventive techniques.

FIGS. 5 and 6 illustrate how different actuating portions of switch assemblies map to corresponding actuators, according to certain inventive techniques.

FIGS. 7A-7F show different patterns of actuators to be actuated at a time, according to certain inventive techniques.

FIG. 8 illustrates a block diagram of a switching device, according to certain inventive techniques.

FIG. 9 illustrates a flowchart for a method of operation of a switching device, according to certain inventive techniques.

The foregoing summary, as well as the following detailed description of certain techniques of the present application, will be better understood when read in conjunction with the appended drawings. For the purposes of illustration, certain techniques are shown in the drawings. It should be understood, however, that the claims are not limited to the arrangements and instrumentality shown in the attached drawings. Furthermore, the appearance shown in the drawings is one of many ornamental appearances that can be employed to achieve the stated functions of the device.

### DETAILED DESCRIPTION

The solutions currently available on the market, in most cases do not offer the possibility of adjusting the switches in a control device (e.g., a wall switch controller). The possibility of replacing the switches gives an opportunity to customize the device and adapt to specific needs while maintaining a single design unit, which is important from the manufacturer's point of view. Interchangeable buttons can have different sizes and can be installed in different configurations, which makes it possible for each user to be able to customize a unit to their needs. The inventive solution is designed differently from existing solutions, therefore reconfiguration of buttons is possible and it offers greater flexibility in the arrangement of keys. Another advantage of the present invention is the feeling of pressing a button, which is unique compared to other buttons reconfiguration solutions.

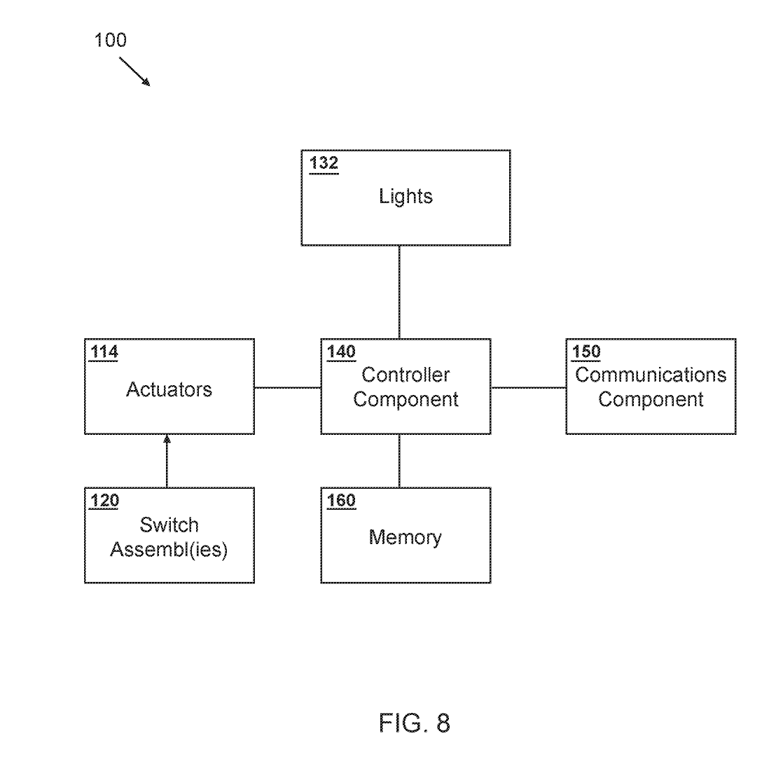

FIG. 8 illustrates a switching device 100, according to certain inventive techniques. The device 100 includes a controller component 140, a communication component 150, a memory 160, one or more lights 132, actuators 114, and one or more switch assemblies 120. The switching device 100 may also include a power source or supply (not shown).

The controller component 140 may include one or more processors (e.g., microprocessors, digital signal processors, or the like), hardware, and/or software. The controller component 140 may execute program instructions (e.g., software) causing it to perform the operations discussed below (in some cases, in conjunction with hardware).

The communication component 150 may communicate with the controller component 140. The communication component 150 may transmit and/or receive communications to/from a remote device. The communications may be across a wired or wireless transmission medium. Suitable wired protocols/mediums include Ethernet, Universal Serial Bus (USB), for example. Exemplary wireless protocols include Z-Wave, WPAN protocols (e.g., Bluetooth or ZigBee), or WLAN protocols (e.g., 802.11 protocols). The controller component 140 may provide information for the communication component 150 to transmit. Conversely the communication component 150 may provide received information to the controller component 140.

The memory 160 may communicate with the controller component 140 (and additionally, the communication component 150). The memory 160 may include more than one memory component. The memory 160 may include volatile and/or non-volatile memory. The memory 160 may include read-only memory (ROM), random access memory (RAM), low latency nonvolatile memory, flash memory, a solid-state memory (SSD), field-programmable gate array (FPGA), and/or other suitable electronic data storage capable of storing data, software (for execution, for example, by the controller component 140 and/or communication component 150) and/or other information.

The light(s) 132 may include one or more light sources visible to a user of the switching device 100. The light(s) 132 may include incandescent lamps or LEDs, for example. The light(s) 132 may be controlled by the controller component 140, either directly or with the use of drivers, such as LED drivers. The light(s) may provide feedback to a user, indicating, for example, whether a switch assembly is depressed, whether the communication component 150 is or is not in communication with a remote device, or the status of the power source (e.g., batteries). Each or all of the lights 132 may have multiple colors—e.g., multi-colored LEDs, such as red, green, blue, and/or white.

The actuators 114 may be in communication with the controller component 140. For example, the controller component 140 may be able to detect the status of the actuators 114 (e.g., open or closed). The actuators 114 may be an integral part of a silicon membrane. These actuators 114 may be actuated by pressing on the membrane, which, after being pressed may return automatically to its original position. The actuators 114 may be formed in the membrane in a way which ensures an appropriate feeling to the actuator 114. There may be carbon rings at on the back side of the actuators 114, which may provide electrical contact with an electrical circuit that detects actuator closure.

The switch assembl(ies) 120 may be depressible, thereby causing one or more of the actuators 114 to be actuated. As explained in detail below, there may be several different types of switch assemblies 120, each of which has an associated pattern. The pattern may cause a corresponding pattern of actuators 114 to be actuated. The controller component 140 may then detect that pattern and recognize that a particular type of switch assembly 120 has been depressed in a particular location (e.g., which row and/or column). The controller component 140 may then store the identity of the depressed switch assembly 120 in memory 160. The identity of the depressed switch assembly 120 may also be sent to the communication component 150 for transmission to a remote device.

The device 100 may also include a power source or supply. For example, the device 100 may include one or more batteries that provide power to the controller component 140, communication component 150, memory 160, and lights 132. Power may also be supplied to the actuators 114, depending on design. Alternatively, power may be provided through an external source, such as an external AC or DC source. The power source or supply may also include power conditioning circuitry, such as a rectifier, capacitor(s), inductor(s), and/or regulators. The power source or supply may be linear and/or switching.

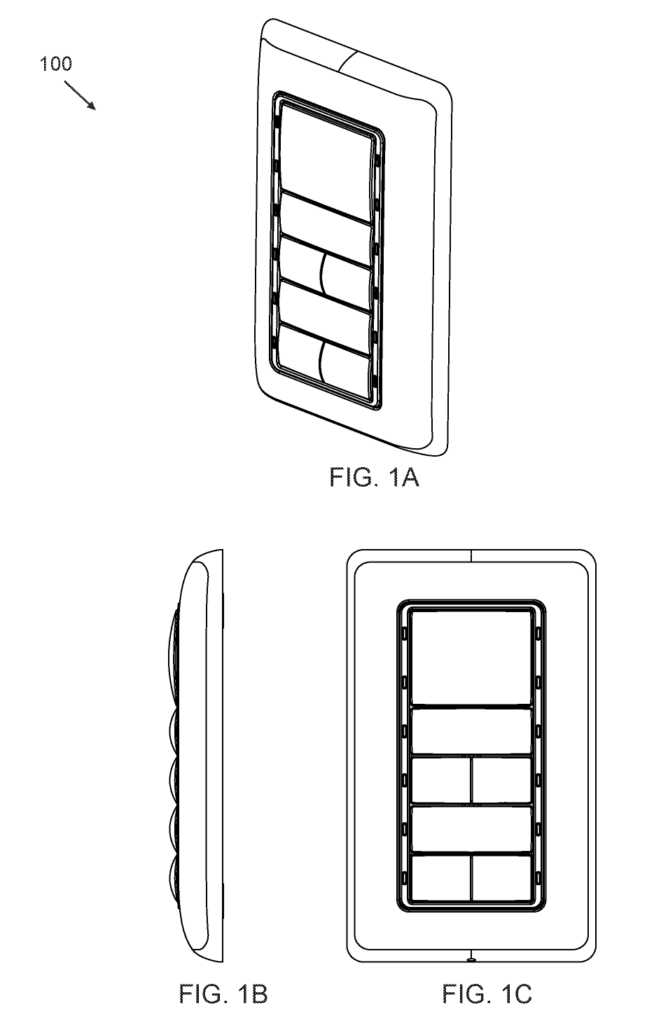

FIGS. 1A, 1B, and 1C show different views of a switching device 100, according to certain inventive techniques. FIG. 1A illustrates a perspective view of the device 100. FIG. 1B illustrates a side view of the device 100. FIG. 1C illustrates a front view of the device 100.

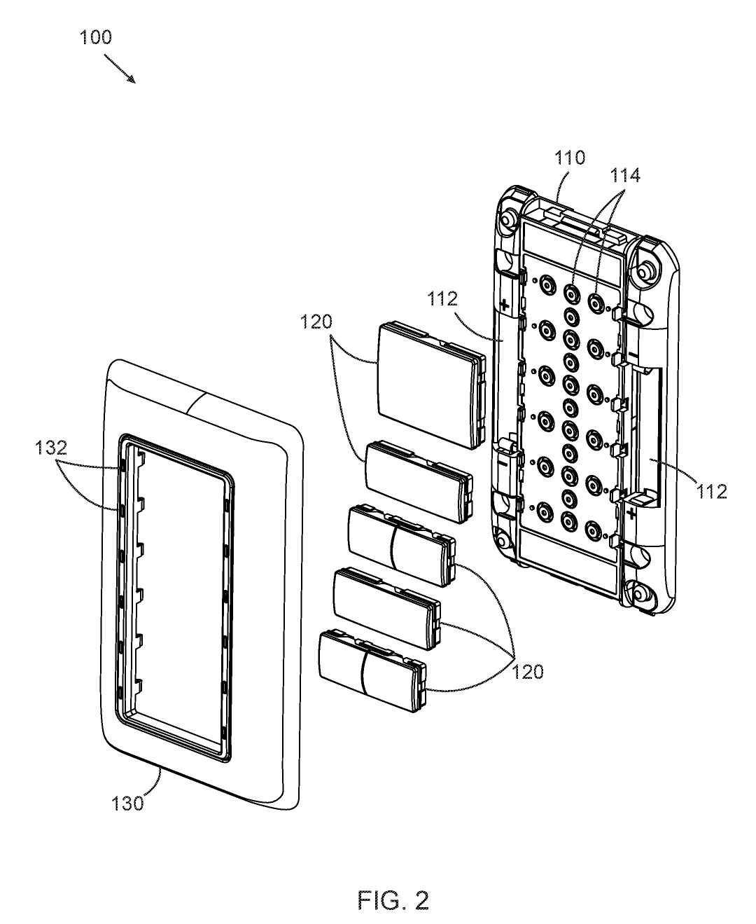

FIG. 2 shows an exploded view of the device 100, which includes an engaging portion 110, switch assemblies 120, and a cover 130. The engaging portion 110 may be mounted to a surface, such as a wall. The engaging portion 110 may include a plurality of actuators 114 and one or more battery compartments 112. The engaging portion 110 may also include or house the controller component 140, communication component 150, and memory 160.

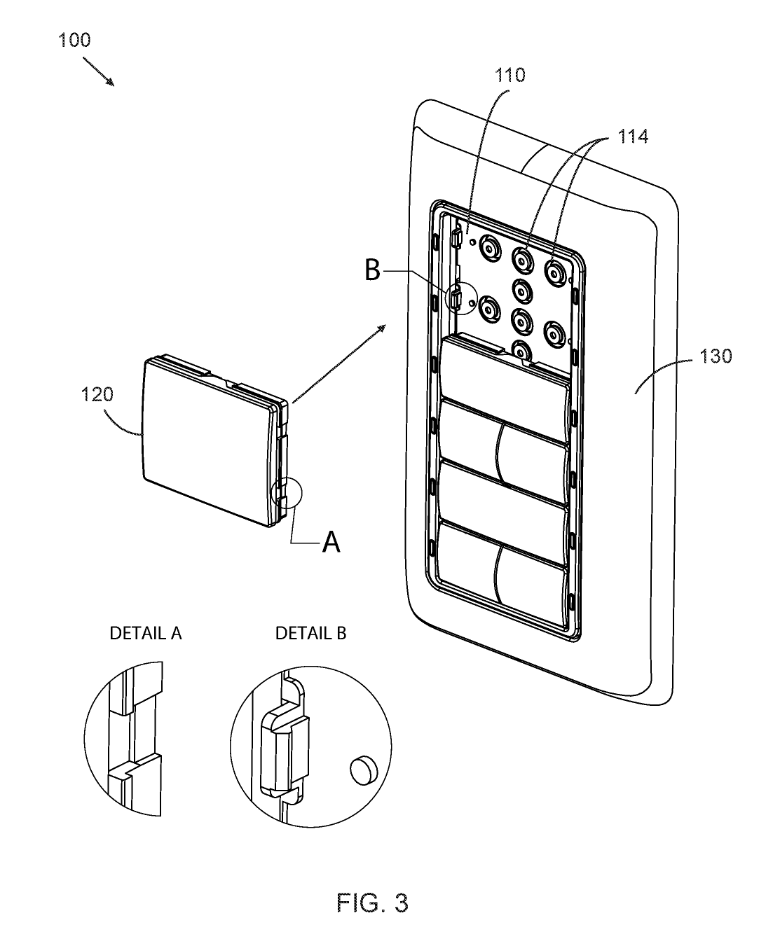

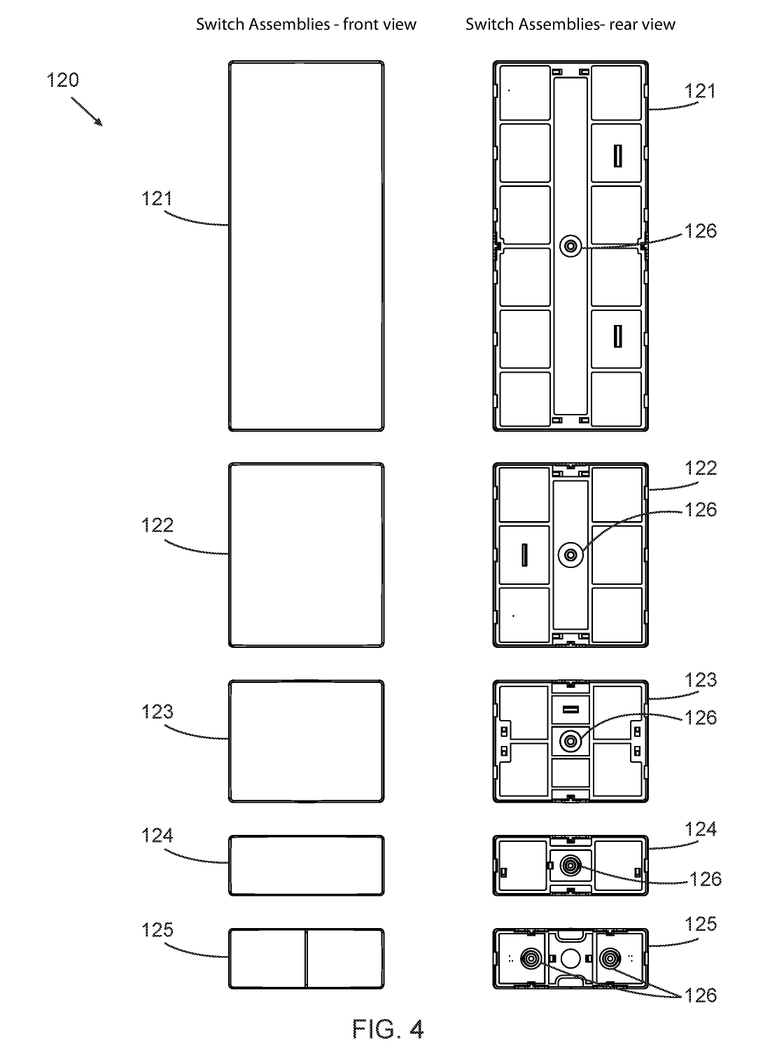

Each of the switch assemblies 120 may engage with the engaging portion 110. A given switch assembly 120 may be removable from the engaging portion 110 without damage to either. A switch assembly 120 may have one or more touch pads on the front and one or more actuating portions (shown in FIG. 4, reference 126, but not viewable in FIG. 3) on the back. A switch assembly 120 may have a spring. When the switch assembly 120 is depressed by a user, the actuating portion(s) 126 may cause the actuators 114 to be actuated. When the user releases the switch assembly 120, the spring may return the switch assembly 120 to its original, non-depressed state, and the actuating portions 126 may be removed from the actuators 114. The switch assembly 120 may provide tactile, visual, and/or audio feedback to a user when the switch assembly 120 has been depressed and/or released.

A switch assembly 120 may optionally receive power when engaged with the engaging portion 110. In this case, the switch assembly 120 may have two or more contacts that connect with corresponding contacts on the engaging portion 110. There may be active components in the switch assembly 120 such as sensors or lights (e.g., LEDs) that may receive electrical power and operate accordingly. For example, as discussed above, the lights may provide visual feedback when the switch assembly 120 is depressed. In the case of sensors, there may be proximity sensors that sense the presence of a nearby user. This could cause, for example, lights in the device 100 to illuminate or the device 100 to wake up from a low power mode.

Sensors could also sense more complicated user interactions with the switch assembly 120, such as gestures (e.g., swiping, pinching, expanding, etc.). Sensing signals may be communicated through additional contacts in the switch assembly 120 and engaging portion 110 to the controller component 140, where appropriate action may be determined. For example, it may be possible for a user to swipe a finger across a touch pad of a switch assembly 120 in order to cause controlled lights to dim or brighten. Under such an example, the controller component 140 could detect a swipe and cause the communication component 150 to communicate a dimming/brightening command to a remote device, which will cause the light fixture to behave accordingly.

The cover 130 may include lights 132 (e.g., LEDs). The cover 130 may mechanically and/or electrically engage with the engaging portion 110. Engagement may be performed with one or more protrusions on the cover 130, which engage with corresponding slot(s) in the engaging portion 110. The lights 132 may be controlled through electrical connections with the engaging portion 110. There may be one or more electrical connection accomplished through each protrusion in the cover 130. For example, there may be an electrical contact on a given protrusion, and that contact may physically connect with a corresponding contact of a slot in the engaging portion 110. There may be one electrical connection for each light 132.

As shown, there are six rows in the device 100. A switch assembly 120 may occupy one or more rows defined in the engaging portion 110 and/or the cover 130. For example, the upper switch assembly 120 occupies two rows. There may be one or more lights 132 on the cover 130 for each row. As shown, there are two lights 132—one on the left and one on right in each row. The lights 132 may provide feedback by illuminating when a switch assembly 120 is depressed and corresponding actuators 114 are actuated. Illumination may be controlled by the controller 140 according to which switch assembl(ies) 120 have been identified and their location (i.e., which row(s) and/or columns they occupy).

FIG. 3 shows the device 100 with further detail on one possible mechanism for engaging a switch assembly 120 with the engaging portion 110. Specifically, the engaging portion 110 is shown to have a springing mechanical engager (detail B) that snaps onto a recess (detail A) in a switch assembly 120. The engager is deflected horizontally when the switch assembly 120 is pushed in. Once inserted to a suitable depth, the spring in the engager causes the engager to return to its non-deflected resting position, thereby engaging the switch assembly 120 with the engaging portion 110.

FIG. 4 shows five different types of switch assemblies 120 (121, 122, 123, 124, and 125). These switch assemblies 120 are merely exemplary. These examples illustrate the concept, which is, of course, not limited to the examples in this specification. The left column depicts a front view of each switch assembly 120, while the right column illustrates a rear view for each switch assembly 120. Each switch assembly 120 has a different arrangement of actuating portions 126. When a given switch assembly 120 is depressed, the actuating portions 126 come into contact with the actuators 114. If there is more than one actuating portion 126 for a switch assembly 120, the corresponding actuators 114 can be actuated at the time. In the case that there are a plurality of actuators 114 that are actuated, the time that one of the actuators 114 is actuated overlaps with the time that the other actuator(s) 114 are actuated.

Actuating portions 126 may have different shapes and orientations. For example actuating portions 126 may engage the actuators 114, thereby moving the force from the surface of the button to the silicone actuator, resulting in sag and short circuit on a printed circuit board (or other circuit construction) through a carbon disc. By means of actuating portions 126, the button after being released, may be returned to its original position. The actuating portions 126 location in each button may be selected to provide a unique combination for the buttons array. This solution allows identification of actuating portions 126 currently mounted on the device, as well as their size and location. The actuating portions 126 arrangement may be selected in such a way that at least one actuator 114 can always be actuated.

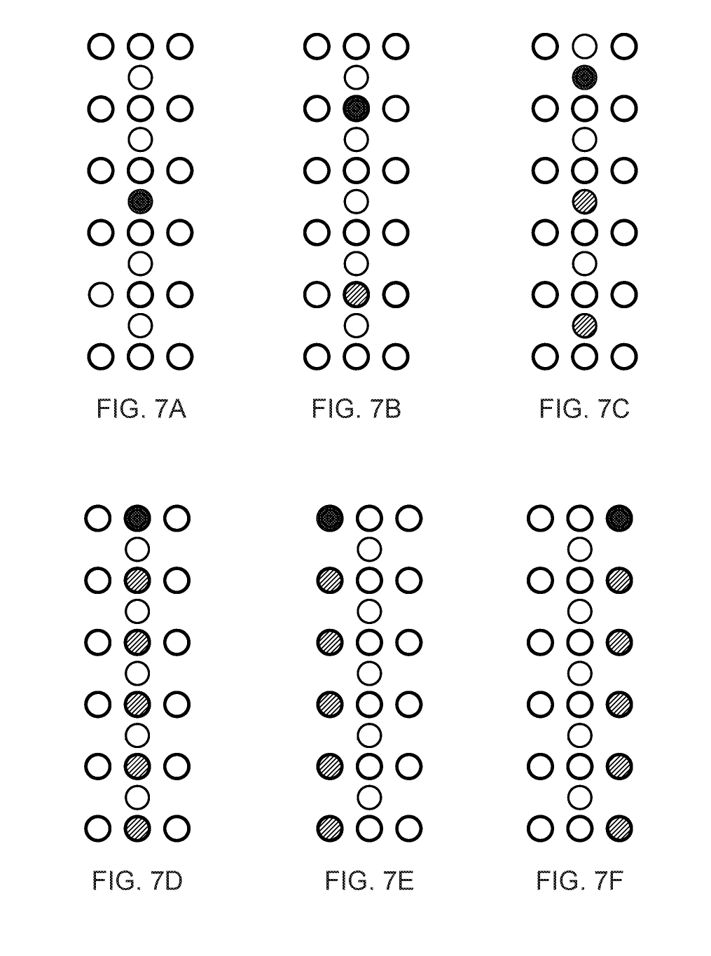

Switch assembly 121 occupies six rows. It has one actuating portion 126. When switch assembly 121 is depressed, it causes a pattern of actuators 114 (in this example, one actuator 114 in the center of the actuators 114, although more are possible) to be actuated at a time, which is shown in FIG. 7A.

Switch assembly 122 occupies three rows. It has one actuating portion 126. When switch assembly 122 is engaged with the engaging portion 110 and occupies the top three rows and is depressed, it causes a pattern of actuators 114 to be actuated at a time, which is shown in FIG. 7B as the solid-fill circles. The pattern can occur and be detected at different locations in the actuators 114, thereby indicating not only the type of switch assembly 121, but the location (e.g., which row/column) it is occupying. This is shown by the slanted-fill circles in FIG. 7B.

Switch assembly 123 occupies two rows. It has one actuating portion 126. When switch assembly 123 is engaged with the engaging portion 110 and occupies the top two rows and is depressed, it causes a pattern of actuators 114 to be actuated at a time, which is shown in FIG. 7C as the solid-fill circles. The pattern can occur and be detected at different locations in the actuators 114, thereby indicating not only the type of switch assembly 121, but the location (e.g., which row/column) it is occupying. This is shown by the slanted-fill circles in FIG. 7C.

Switch assembly 124 occupies one row. It has one actuating portion 126. When switch assembly 124 is engaged with the engaging portion 110 and occupies the top row and is depressed, it causes the pattern of actuators 114 to be actuated at a time, which is shown in FIG. 7D as the solid-fill circle. The pattern can occur and be detected at different locations in the actuators 114, thereby indicating not only the type of switch assembly 121, but the location (e.g., which row/column) it is occupying. This is shown by the slanted-fill circles in FIG. 7D.

Switch assembly 125 also occupies one row, but it has a left portion and a right portion that can be separately depressed (thereby leading to two different actions such as turning a light on/off). It has two actuating portions 126. When switch assembly 125 is engaged with the engaging portion 110 and occupies the top row and is depressed on the left side, it causes the pattern of actuators 114 to be actuated at a time, which is shown in FIG. 7E as the solid-fill circle. When switch assembly 125 is engaged with the engaging portion 110 and occupies the top row and is depressed on the right side, it causes the pattern of actuators 114 to be actuated at a time, which is shown in FIG. 7F as the solid-fill circle. It is possible to extend the same left/right concept to a switch assembly 120 with a top portion and a bottom portion. The pattern can occur and be detected at different locations in the actuators 114, thereby indicating not only the type of switch assembly 121, but the location (e.g., which row/column) it is occupying. This is shown by the slanted-fill circles in FIGS. 7E and 7F.

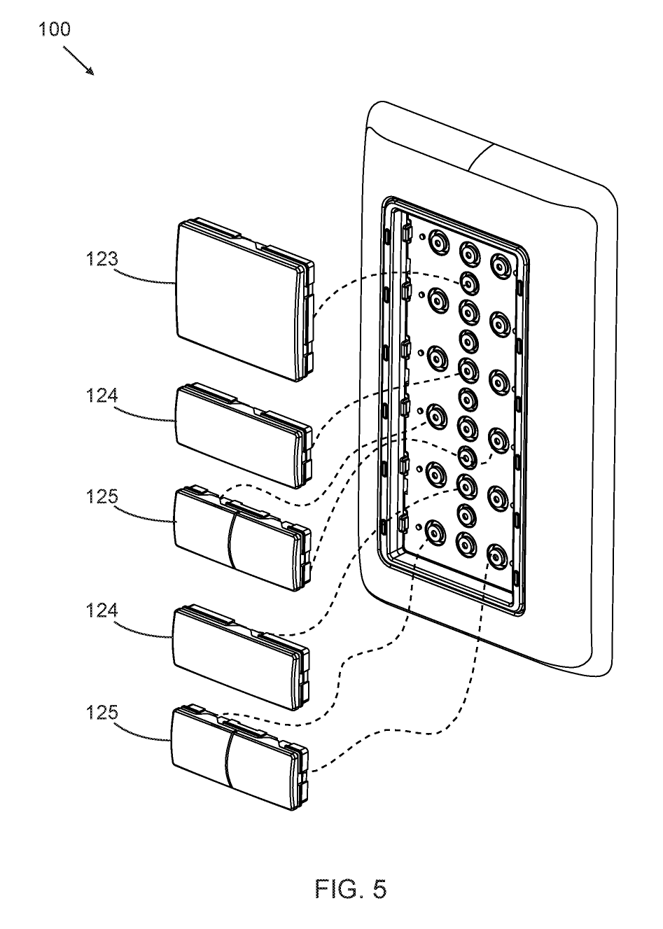

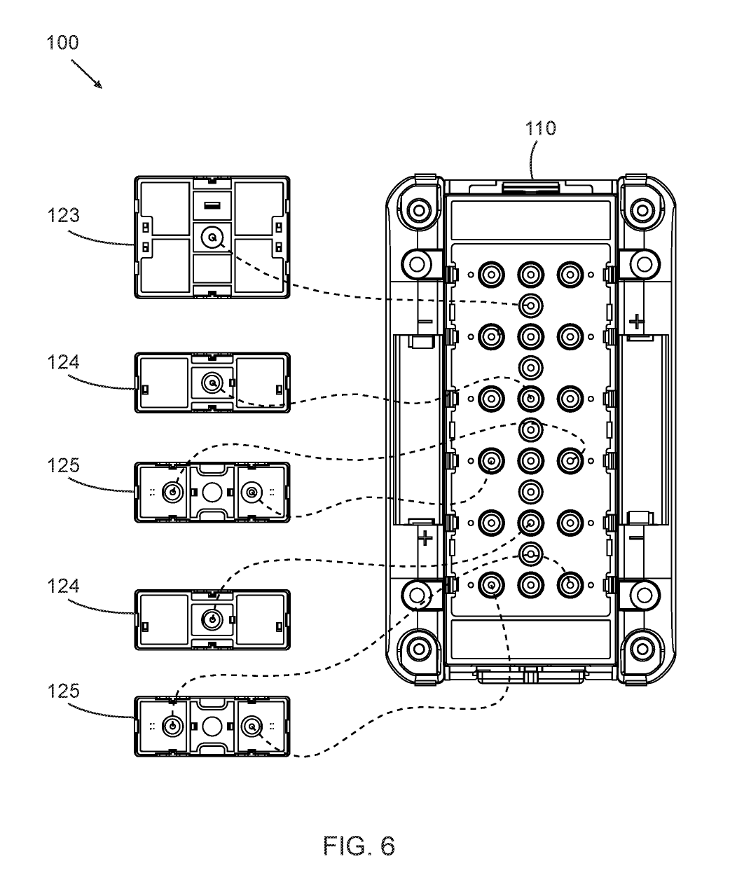

FIGS. 5 and 6 illustrate how different actuating portions 126 of switch assemblies 120 map to the actuators 114. As can be seen in FIGS. 7A-7F, the patterns may differ in a horizontal and/or vertical dimension, thereby allowing the controller component 140 to recognize what type of switch assembly 120 is installed and depressed.

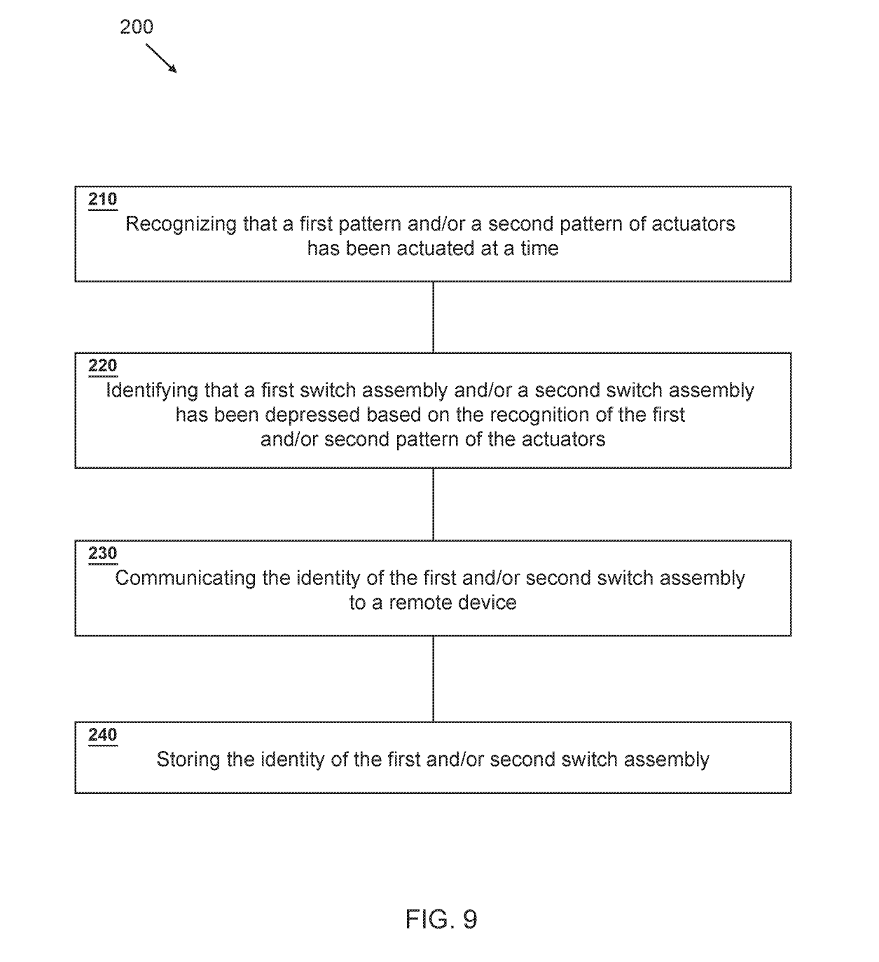

FIG. 9 illustrates a flowchart 200 for a method of operation of a switching device, according to certain inventive techniques. Some of the steps shown (e.g., steps 230 and 240) may be optional, performed in a different order, and/or performed simultaneously. For example, the flowchart 200 may be implemented by device 100 (as will be described below). Certain steps (e.g., 210 and 220) may be performed by the controller component 140 executing program instructions stored on a non-transitory computer readable device (e.g., memory 160).

At step 210, a first pattern and/or a second pattern of actuators 114 actuated at a time are recognized. Such recognition may be performed by controller component 140. The actuators 114 may be in communication with inputs to the controller component 140, and based on these inputs, the controller component may detect and recognize the status of the actuators 114 (e.g., open or closed), thereby recognizing the pattern.

Performance of step 220 includes identifying that a first switch assembly 120 and/or a second switch assembly 120 has been depressed based on the recognition of the first and/or second pattern of the actuators 114. For example, if a first pattern is detected, then a first switch assembly 120 may be identified. On the other hand, if a second pattern is detected, then a second switch assembly 120 may be identified. The first and second switch assemblies (like the first and second patterns) are different. A given pattern may uniquely identify a switch assembly 120. Such identification may be performed by controller component 140—for example, using a look-up table.

At step 230, the identity of the first and/or second switch assembly 120 is communicated via the communication component 150 to a remote device. The communication component 150 may receive the identity of the first and/or second switch assembly 120 from the controller component 140. Alternatively, the communication component may retrieve the identit(ies) from the memory 160. At step 240, the identity of the first and/or second switch assembly 120 is communicated via the communication component 150 to a remote device.

An exemplary operation of the device 100 follows. One or more switch assemblies 120 are engaged with the engaging portion 110. Optionally, prior to engagement, pre-existing switch assemblies 120 may be disengaged from the engaging portion 110 and removed. An initialization sequence is instigated (for example, by a remote device communicating with the device 100 or by interacting with the device—e.g., holding an actuator down for a pre-determined period of time or inserting batteries into the battery compartment(s) 112). A first type of switch assembly 120 is installed in one location of the engaging portion 110 and a second switch assembly 120 is installed in another location of the engaging portion 110. The first switch assembly 120 is depressed for a predetermined period of time. The actuators 114 are correspondingly actuated in a first pattern. The controller component 140 recognizes this pattern and the location of the first switch assembly 120 (i.e., which rows/columns are occupied). The process is repeated for the second switch assembly, and the second pattern is recognized.

One or more lights 132 are illuminated (for example, constantly or intermittently by the controller component 140) to indicate that the first switch assembly has been successfully or unsuccessfully installed. When successfully installed, the illuminating lights 132 may be on the left and/or right in one or more of the rows which are occupied by the switch assembly 120. If unsuccessful, no lights 132 may be illuminated, or the lights 132 may illuminate in a different color (e.g., red instead of green), or all of the lights 132 may illuminate (e.g., flashing). The identity of the switch assembly 120 may be recorded by the controller component 140 in the memory 160. Such identifying information may include the type and/or the location of switch assembly 120. This information may also optionally be communicated by the communication component 150 to a remote device.

After initialization, when the first or second switch assembly 120 is depressed (or a user interacts with it using a gesture), this status is communicated by the communication component 150 to a remote device where appropriate action is taken (lights go on/off or are dimmed). If a user depresses the first or second switch assembly 120 for a period of time, this status may be repetitively sent (for example, to progressively dim or brighten a remote light source).

It will be understood by those skilled in the art that various changes may be made and equivalents may be substituted without departing from the scope of the novel techniques disclosed in this application. In addition, many modifications may be made to adapt a particular situation or material to the teachings of the novel techniques without departing from its scope. Therefore, it is intended that the novel techniques not be limited to the particular techniques disclosed, but that they will include all techniques falling within the scope of the appended claims.

1. A device comprising:
an engaging portion configured to mechanically engage with at least one switch assembly;
a controller component; and
a plurality of actuators, wherein each of the plurality of actuators is capable of being actuated by the at least one switch assembly when the at least one switch assembly is engaged with the engaging portion and depressed;
wherein the controller component is configured to:
detect a first pattern of the plurality of actuators actuated at a time and responsively recognize a first type of switch assembly;
detect a second pattern of the plurality of actuators actuated at a time and responsively recognize a second type of switch assembly;
the first pattern of the plurality of actuators is different from the second pattern of the plurality of actuators; and
the first type of switch assembly and the second type of switch assembly are different.

2. The device of claim 1, further comprising:
a communication component in communication with the controller component and configured to send at least one communication to a remote device; and
wherein the at least one communication includes information indicating whether at least one of the first type of switch assembly or the second type of switch assembly has been depressed.

3. The device of claim 2, wherein the communication component sends the communications wirelessly to the remote device.

4. The device of claim 2, further comprising a memory, wherein the controller component stores an identity of the one or more determined switch assemblies.

5. The device of claim 2, further comprising at least one battery receiving compartment each configured to receive at least one battery, wherein the received at least one battery provides power to the controller component and the communication component.

6. The device of claim 1, wherein the first pattern of the plurality of actuators comprises only one actuator.

7. The device of claim 1, wherein the first pattern of the plurality of actuators comprises a plurality of the actuators.

8. The device of claim 1, wherein the first pattern differs from the second pattern in a horizontal dimension.

9. The device of claim 1, wherein the first pattern differs from the second pattern in a vertical dimension.

10. The device of claim 1, wherein the first pattern differs from the second pattern in a horizontal dimension and a vertical dimension.

11. The device of claim 1, wherein the engaging portion comprises a plurality of rows to receive the at least one switch assemblies.

12. The device of claim 11, wherein:
the first type of switch assembly occupies only one of the rows; and
the second type of switch assembly occupies a plurality of the rows.

13. The device of claim 11, wherein the first type of switch assembly comprises a left portion and a right portion each of which is capable of being separately depressed, thereby causing actuation of different ones of the plurality of actuators.

14. A method comprising;
recognizing, with a controller component, that a first pattern of a plurality of actuators has been actuated at a time; and
identifying, with the controller component, that a first switch assembly has been depressed based on the recognition of the first pattern of the plurality of actuators.

15. The method of claim 14, further comprising communicating, with a communication component, the identity of the first switch assembly to a remote device.

16. The method of claim 14, further comprising storing, in a memory in communication with the controller component, the identity of the first switch assembly.

17. The method of claim 14, further comprising:
recognizing, with the controller component, that a second pattern of a plurality of actuators has been actuated at a time; and
identifying, with the controller component, that a second switch assembly has been depressed based on the recognition of the second pattern of the plurality of actuators.

18. The method of claim 17, wherein the first pattern of the plurality of actuators comprises only one actuator.

19. The method of claim 17, wherein the first pattern of the plurality of actuators comprises a plurality of the actuators.

20. The method of claim 17, wherein the first pattern differs from the second pattern in a horizontal dimension.

21. The method of claim 17, wherein the first pattern differs from the second pattern in a vertical dimension.

22. The method of claim 17, wherein the first pattern differs from the second pattern in a horizontal dimension and a vertical dimension.
